(19) United States
(12) Patent Application Publication
(10) Pub. No.: US 2003/0066801 A1
(43) Pub. Date: Apr. 10, 2003

(54) Dental unit water system treatment

(75) Inventors: Edgar L. Garrison, Spring Lake, MI (US); John E. Garrison, Spring Lake, MI (US); Kevin S. Walburg, Grand Haven, MI (US)

Correspondence Address: MCGARRY BAIR PC, 171 MONROE AVENUE, N.W., SUITE 600, GRAND RAPIDS, MI, 49503, US

(73) Assignee: Garrison Dental Solutions, Spring Lake, MI (US)

(21) Appl. No.: 10/065,249

(22) Filed: Sep. 27, 2002

Related U.S. Application Data
(60) Provisional application No. 60/326,325, filed on Oct. 1, 2001.

(51) Int. Cl. B01D 11/00

(52) U.S. Cl. 210/639; 210/198.1; 210/257.1; 210/749; 210/764; 422/14

(57) ABSTRACT

A treatment for a dental water unit system comprises a shock treatment including silver colloid and hydrogen peroxide that stays in the system for an extended period, followed by a flushing of the system and the addition of a maintenance solution comprising at least silver colloid in an amount safe for human consumption.

### CROSS REFERENCE TO RELATED APPLICATIONS

This application claims the benefit of U.S. application Ser. No. 60/326,325 filed Oct. 1, 2001.

### BACKGROUND OF THE INVENTION

1. Field of the Invention

The present invention relates to purification of dental unit water systems and, more particularly, to a method of treating dental unit water systems utilizing a silver colloid-hydrogen peroxide solution, to provide uncontaminated water at the point of use.

2. Description of the Related Art

Tap water in dental offices is similar to tap water in most homes and offices. While this water is generally considered safe to drink, it is never sterile. Most tap water samples contain fewer than 50 cfu (colony forming units) of bacteria per milliliter (cfu/ml). However, once tap water is placed in a closed system such as exists in a dental chair, the long plastic tubing (dental unit water lines) that feeds into dental high-speed handpieces and other dental implements, such as air-water syringes and ultrasonic tooth scalers, the environment changes. Here, the flow rates, frequent periods of stagnation and large relative surface area of the small bore plastic lines are ideal for microbial contamination. Water that stagnates in reservoirs and/or dental unit water lines overnight and even during long periods during the day provides bacteria the opportunity to grow. Cooperating populations of several different species, which depend on each other for survival or are otherwise symbiotically related, continue to multiply and form a matrix that provides nutrients and mutual protection. Studies of dental unit water lines reveal bacterial population explosions averaging over 500,000 cfu/ml and often exceeding 1,000,000 cfu/ml. Thus far, researchers have identified pathogens and opportunists in dental equipment such as Pseudomonas, Legionella, Staphylococci, Streptococci, Nocardia, Serratia, Klebsiella, Moraxella, Bacteroides, Flavobacterium, Escherichia, several species of amoebae known to serve as hosts for Legionella pneumophila and even nematodes (worms).

Various solutions to prevent exposure of dental patients to contaminated water have been proposed. Such proposals include flushing the dental unit water lines with distilled water or chemicals, but flushing with distilled water is at best a temporary solution. Sterilization of dental instruments between patients has little effect in preventing the microbes in the dental water from entering the next patient”s mouth. Using disposable sterile water lines between patients does not solve the problem of contaminated water upstream and downstream of the disposable portion. Use of containers having sterile or distilled water is effective only if the water conveying lines are replaced after each patient and if the water does not become contaminated prior to disposal of used water lines. Use of electrical current or ozone generators, alone or in combination with antimicrobial agents is impractical due to unavailability of inexpensive ready-to-use equipment. Distilling the water received from a municipal water source addresses contaminants in the water, but the distilled water is easily contaminated once in the lines. To date, devices using 0.2 micron filters or the like are reasonably effective to prevent transmission of microbes past the filters, provided the filters are replaced at least daily and that the process of such replacement does not permit a colony of microbes to be conveyed to a water line downstream of the filter. It is evident that a significant health hazard exists for patients using a dental office and the need for a viable, cost-effective solution remains.

### SUMMARY OF THE INVENTION

This need is met in the present invention of a treatment for dental unit water systems comprising an undiluted shock solution and a maintenance solution. The shock solution is germicidal in that it is strong enough to kill potentially harmful microbes. The maintenance solution will inhibit the growth or reintroduction of harmful microbes, but is safe for human consumption. Preferably, the undiluted shock solution includes silver colloid present at a concentration of 5-25 ppm and hydrogen peroxide present at a concentration of 0.3% -30% by weight. The maintenance solution includes silver colloid present at a concentration of 5-25 ppm and hydrogen peroxide present at a concentration of 0% to 30% by weight, but the maintenance solution is diluted with distilled water at a ratio of one part maintenance solution to 32 parts water.

Preferably, the undiluted shock solution includes a first colorant and the diluted maintenance solution includes a second colorant. The shock treatment can include a trace amount of sodium bicarbonate. The shock treatment will typically be separated into a first container containing all of the silver colloid and a second container containing all of the hydrogen peroxide for extended storage.

In another aspect of the invention, a method is provided for treating dental water unit systems of the type comprising a reservoir, at least one dental water unit line, and at least one dental instrument, all in fluid communication and where water will flow from the reservoir through the dental water unit line and exit from the dental instrument. The method includes the steps of placing an undiluted shock treatment into a reservoir of a dental water unit system, directing the undiluted shock treatment through the dental water unit system until the dental water unit system is full of shock treatment, flushing the dental water unit system with more undiluted shock treatment; and replacing the shock treatment with a diluted maintenance treatment.

Preferably, the undiluted shock treatment is placed into the reservoir for at least 24 hours. Also, the dental water unit system is typically flushed for 20-30 seconds. The shock treatment preferably comprises silver colloid present at a concentration of 5-25 ppm and hydrogen peroxide present at a concentration of 0.3% -30% by weight. And the diluted maintenance treatment typically comprises a solution of water and silver colloid present at a concentration of 5-25 ppm and hydrogen peroxide present at a concentration of 0% to 30% by weight. But the solution is diluted with distilled water at a ratio of one part maintenance solution to 32 parts distilled water.

The shock treatment can also include a first colorant and the maintenance treatment can have a second colorant. In this embodiment, the replacement step comprises placing the maintenance treatment into the reservoir and directing it through the dental water unit system until the first colorant is visually replaced by the second colorant. In another embodiment, undiluted maintenance treatment is in the form of a prepackaged amount and the reservoir has a visual indicium corresponding to a predetermined solution when the prepackaged amount and water are added to the reservoir.

### DETAILED DESCRIPTION

The invention lies in a treatment for maintaining uncontaminated water in closed dental unit water systems. Many dental chairs used in dental offices are closed systems where the water for oral irrigation is self-contained. A dental unit water line is any one of several lines for conveying fluid from a reservoir to the dental instruments. The dental unit water system thus includes the reservoir, the dental instruments, the dental unit water lines, and any other components that come into contact with fluids from the reservoir during normal use. The reservoir is typically a plastic container designed to hold a predetermined amount of water. Depending upon the design of the chair, the reservoir may require manual filling or may be filled by automatic connection to a water source, e.g., tap water.

A treatment system according to the invention contemplates use of a shock treatment and a maintenance treatment. Typically, a dentist office will be closed for at least 24 hours out of each week. A shock treatment according to the invention is to be used after the last use of the dental chair prior to closing the office for at least 24 hours. The water reservoir in the chair is removed and emptied. An undiluted shock treatment formula is placed into the reservoir, and the reservoir is replaced in the dental chair. The shock solution germicidal in that it includes any chemical that it is strong enough to kill potentially harmful microbes. One optional shock treatment includes a pre-mixed 500 ml solution of shock treatment formula containing 440 ml of 5 ppm-25 ppm silver colloid, 60 ml of 0.3%-30% by weight hydrogen peroxide, a small amount of coloring, and a trace amount of sodium bicarbonate. In this solution, the coloring will comprise water, propylene glycol, FD&C Red #40, and FD&C Red #3. The target yield of active ingredients in the resulting shock treatment formula is 17.6 ppm silver and 3.15 % by weight hydrogen peroxide. A limitation of the premixed solution is that the silver and hydrogen peroxide tend to break down over time. For product stability; it has been found that a shock treatment comprising one container of 4 oz. of 15 ppm silver colloid and a separate container of 4 oz. of 6% by weight hydrogen peroxide yields 7.5 ppm silver and 3% hydrogen peroxide when mixed prior to use.

The undiluted shock treatment formula is placed in the reservoir and directed from the reservoir through each water line attached to the dental chair for 20-30 seconds or until the coloration of the shock treatment formula is seen exiting the line. The shock treatment formula is allowed to remain in the system throughout the period in which the dental office is closed, typically a weekend. An acceptable range of ingredients for an effective shock solution is 0.3% -30% by weight hydrogen peroxide and a minimum of 0 ppm silver colloid.

Prior to returning the dental chair to active use, each water line is flushed with shock treatment formula from the reservoir for about 20-30 seconds in order to detach any biofilm that may have accumulated inside the lines and to help prevent clogging of the dental instruments. Thereafter, the reservoir is removed from the dental chair, and any remaining shock treatment formula in the reservoir is discarded.

A maintenance treatment solution is then prepared and placed into the reservoir. The maintenance solution will include chemicals that inhibit the growth or reintroduction of harmful microbes, but remain safe for human consumption, perhaps in an undiluted state, but preferably diluted. A preferred maintenance treatment solution is formed by diluting one part maintenance treatment formula into thirty-two parts distilled water. A typical undiluted 125 ml solution of maintenance treatment formula contains 100 ml of 8 ppm-25 ppm silver colloid, 25 ml of 0.0%-30% by weight hydrogen peroxide, a small amount of coloring, and a trace amount of sodium bicarbonate. Preferably, the coloring will comprise water, propylene glycol, and FD&C Blue #1. The target yield for the maintenance treatment solution is 0.5 ppm silver and 0.1641 percent hydrogen peroxide. An acceptable range of ingredients for an effective maintenance solution is 5-25 ppm silver colloid and a maximum of 30% by weight hydrogen peroxide. A preferred maintenance treatment solution comprises 4 oz. of 15 ppm silver colloid with no hydrogen peroxide, which when diluted in distilled water, yields a solution with 0.5 ppm silver and 0% hydrogen peroxide. It has been found that the presence or absence of hydrogen peroxide in the diluted maintenance treatment formula makes no appreciable difference in effectiveness. A benefit of having no hydrogen peroxide in solution is that the undiluted maintenance treatment formula will have a longer shelf life.

The prepared maintenance treatment solution is placed in the reservoir, and the reservoir reattached to the dental chair. Each dental unit water line is then flushed with the maintenance treatment solution until the coloration of the shock treatment formula is replaced by the coloration of the maintenance treatment solution. The dental unit water lines will now be ready for patient use. It will be understood that the maintenance treatment solution is fully capable of consumption by patients with no harmful effects.

For ease in preparing the maintenance treatment solution, a predetermined amount of maintenance treatment formula can be supplied in a package or container, and a visual indicium, such as a fill line, can be placed on the reservoir at an appropriate level. The appropriate level would be predetermined such that when the predetermined amount of maintenance treatment formula is placed in the reservoir, the proper dilution will automatically occur when distilled water is added to the reservoir until the solution reaches the fill line. It is preferable that only distilled water be used in order to minimize interference with the anti-microbial properties of the maintenance treatment solution.

Testing has revealed the effectiveness and acceptable ranges of active ingredients. A dental unit water line treatment system according to the invention was tested in six dental chairs at different strength levels. Prior to use, baseline samples were taken from all six dental chairs in a dentist”s office, and sent to a lab where cultures were incubated and counted at 48 hours and 72 hours. The results are seen in Table 1:

TABLE 1

| Room | 48 hr CFU | 72 hr CFU |
|---|---|---|
| 1 | 200 | 450 |
| 2 | 1300 | 2350 |
| 3 | *TNTC | TNTC |
| 4 | 1400 | 1900 |
| 5 (control) | 1550 | 2700 |
| 6 | TNTC | TNTC |

*TNTC means “too numerous to count.”

A shock treatment solution was prepared and used in each chair according to the following concentrations in Table 2:

TABLE 2

| Room | AG+ | | H₂O₂ |
|---|---|---|---|
| 1 | 10 | ppm | .3% |
| 2 | 10 | ppm | .3% |
| 3 | 10 | ppm | .3% |
| 4 | 10 | ppm | .3% |
| 5 (control) | 0 | | 0 |
| 6 | 10 | ppm | .3% |

Samples were then taken from all six dental chairs after use of the shock treatment formula with the following results in Table 3:

TABLE 3

| Room | 48 hr CFU | 72 hr CFU |
|---|---|---|
| 1 | <1.0 | <1.0 |
| 2 | <1.0 | <1.0 |
| 3 | <1.0 | <1.0 |
| 4 | <1.0 | <1.0 |
| 5 (control) | TNTC | TNTC |
| 6 | <1.0 | <1.0 |

A maintenance formula was prepared and used in each dental chair according to the following concentrations in Table 4:

TABLE 4

| Room | AG+ | | H₂O₂ |
|---|---|---|---|
| 1 | .25 | ppm | 0 |
| 2 | .5 | ppm | 0 |
| 3 | .75 | ppm | 0 |
| 4 | 1 | ppm | 0 |
| 5 (control) | 0 | | 0 |
| 6 | .5 | ppm | .03% |

Samples were then taken from all six dental chairs after two weeks” use of the maintenance formula solution with the following results seen in Table 5:

TABLE 5

| Room | 48 hr CFU | 72 hr CFU |
|---|---|---|
| 1 | <1.0 | <1.0 |
| 2 | <1.0 | <1.0 |
| 3 | <1.0 | <1.0 |
| 4 | <1.0 | <1.0 |
| 5 (control) | TNTC | TNTC |
| 6 | <1.0 | <1.0 |

It can be seen that the present invention provided an effective solution to the problem of contaminants in dental unit water lines. Reasonable variations and modifications can readily be made without departing from the scope of the invention.

1. A treatment for dental unit water systems comprising:
an undiluted shock solution with silver colloid present at a concentration of 5-25 ppm and hydrogen peroxide present at a concentration of 0.3% -30% by weight; and
a maintenance solution with solver colloid present at a concentration of 5-25 ppm and hydrogen peroxide present at a concentration of 0% -30% by weight,
wherein the maintenance solution is diluted with distilled water at a ratio of one part maintenance solution to 32 parts water.

2. The treatment of claim 1 wherein the undiluted shock treatment includes a first colorant and the diluted maintenance solution includes a second colorant.

3. The treatment of claim 1 wherein the shock treatment includes a trace amount of sodium bicarbonate.

4. The treatment of claim 1 wherein the shock treatment is separated into a first container containing all of the silver colloid and a second container containing all of the hydrogen peroxide for extended storage.

5. A method of treating dental water unit systems of the type comprising a reservoir, at least one dental water unit line, and at least one dental instrument, all in fluid communication and where water will flow from the reservoir through the at least one dental water unit line and exit from the at least one dental instrument, the method comprising the steps of:
placing an undiluted shock treatment into a reservoir of a dental water unit system;
directing the undiluted shock treatment through the dental water unit system until the dental water unit system is full of shock treatment;
flushing the dental water unit system with more undiluted shock treatment; and
replacing the shock treatment with a diluted maintenance treatment.

6. The method of claim 5 wherein the undiluted shock treatment is placed into the reservoir for at least 24 hours.

7. The method of claim 5 wherein the dental water unit system is flushed for 20-30 seconds.

8. The method of claim 5 wherein the shock treatment comprises silver colloid present at a concentration of 5-25 ppm and hydrogen peroxide present at a concentration of 0.3% -30% by weight.

9. The method of claim 5 wherein the diluted maintenance treatment comprises a solution of water and silver colloid present at a concentration of 5-25 ppm and hydrogen peroxide present at a concentration of 0% -30% by weight, said solution diluted with distilled water at a ratio of one part maintenance solution to 32 parts distilled water.

10. The method of claim 5 wherein the shock treatment comprises a first colorant and the maintenance treatment comprises a second colorant, and the replacement step comprises placing the maintenance treatment into the reservoir and directing it through the dental water unit system until the first colorant is visually replaced by the second colorant.

11. The method of claim 5 wherein the undiluted maintenance treatment is in the form of a prepackaged amount and the reservoir has a visual indicium corresponding to a predetermined solution when the prepackaged amount and water are added to the reservoir.
